(19) United States
(12) Patent Application Publication
(10) Pub. No.: US 2018/0014602 A1
(43) Pub. Date: Jan. 18, 2018

(54) METHOD OF MAKING A MOISTURE-PERMEABLE AND WATERPROOF VAMP FOR A SHOE

(71) Applicants: HUGE DEVELOPMENT LIMITED, Hong Kong (CN); SHUANG BANG INDUSTRIAL CORP., Nantou City (TW)

(72) Inventors: Chung-Tang CHANG, Nantou City (TW); Ho-Pin LIN, Taichung City (TW)

(21) Appl. No.: 15/210,083

(22) Filed: Jul. 14, 2016

(51) Int. Cl. A43B 7/12; B32B 5/02; A43B 13/28; B32B 27/40; A43B 23/02; B32B 37/14

(52) U.S. Cl. CPC A43B 7/125; A43B 23/022; B32B 37/14; A43B 23/0205; A43B 23/026; A43B 13/28; B32B 27/40; B32B 5/02; B32B 2307/726; B32B 2307/73; B32B 2437/02

(57) ABSTRACT

A method of making a moisture-permeable and waterproof vamp includes: (a) providing inner and outer fabric layers, each of the inner and outer fabric layers having a top surface and a bottom surface; (b) forming a moisture-permeable and waterproof resin layer on one of the bottom surface of the outer fabric layer and the top surface of the inner fabric layer; (c) attaching the resin layer to the other one of the bottom surface of the outer fabric layer and the top surface of the inner fabric layer so as to obtain a fabric laminate; (d) cutting and forming the fabric laminate into a vamp that is formed with at least one seam; and (e) applying a waterproof treatment to the seam.

### FIELD

The disclosure relates to a method of making a moisture-permeable and waterproof vamp for a shoe.

### BACKGROUND

Vamps for shoes, such as walking shoes, sneakers or boots, may be made from fabrics. The shoes made from the fabrics have the advantages of breathability and perspiration repellence, but are not water resistant.

However, when the shoes with the breathable fabric vamps, e.g., golf shoes or tennis shoes, are worn in a wet environment, e.g., wet grass, the vamps are likely to become wet and the moisture may enter into the shoes.

In order to prevent the aforementioned problem, a water repellent agent may be coated on the outer surface of the vamp to achieve the waterproof and antifouling effects. However, the vamp coated with the water repellent agent may still become wet when the user runs in heavy rain or steps into water. Moreover, coating of the water repellent agent may be only conducted on the vamp that is made from a porous fabric having small pore size. Further, the water repellent agent coated on the outer surface of the vamp is likely to be abraded and is required to be frequently reapplied on the vamp.

### SUMMARY

Therefore, an object of the disclosure is to provide a method of making a moisture-permeable and waterproof vamp for a shoe that can alleviate at least one of the drawbacks of the prior art.

According to the disclosure, the method of making a moisture-permeable and waterproof vamp for a shoe includes the steps of:

(a) providing an outer fabric layer and an inner fabric layer, each of the outer fabric layer and the inner fabric layer having a top surface and a bottom surface that is opposite to the top surface;

(b) forming a moisture-permeable and waterproof resin layer on one of the bottom surface of the outer fabric layer and the top surface of the inner fabric layer;

(c) attaching the resin layer to the other one of the bottom surface of the outer fabric layer and the top surface of the inner fabric layer so that the resin layer is interposed between the inner fabric layer and the outer fabric layer so as to obtain a moisture-permeable and waterproof fabric laminate;

(d) cutting and forming the moisture-permeable and waterproof fabric laminate into a vamp that is formed with at least one seam and that is provided with a receiving space for receiving a user's foot; and

(e) applying a waterproof treatment to the seam.

Another object of the disclosure is to provide a method for making a moisture-permeable and waterproof shoe that can alleviate at least one of the drawbacks of the prior art.

According to the disclosure, the method for making a moisture-permeable and waterproof shoe includes the steps of:

preparing a moisture-permeable and waterproof vamp according to the aforementioned method; and

disposing a shoe tree in the receiving space of the vamp for maintaining a configuration of the vamp;

attaching a shoe sole to a bottom of the vamp; and

removing the shoe tree from the receiving space.

### BRIEF DESCRIPTION OF THE DRAWINGS

Other features and advantages of the disclosure will become apparent in the following detailed description of the embodiment with reference to the accompanying drawings, of which:

FIG. 1 is a flowchart illustrating the embodiment of a method of making a moisture-permeable and waterproof vamp for a shoe according to the disclosure;

FIG. 2 is a fragmentary sectional view showing an inner fabric layer and an outer fabric layer used in step (a) of the embodiment;

FIG. 3 is a fragmentary sectional view illustrating step (b) of the embodiment;

FIG. 4 is a fragmentary sectional view illustrating step (c) of the embodiment;

FIG. 5 is a top view illustrating step (d) of the embodiment;

FIG. 6 is a schematic view illustrating step (d) of the embodiment;

FIG. 7 is a schematic view illustrating step (e) of the embodiment;

FIG. 8 is a schematic view illustrating disposing a shoe tree in a receiving space of a vamp obtained after step (e) of FIG. 7; and

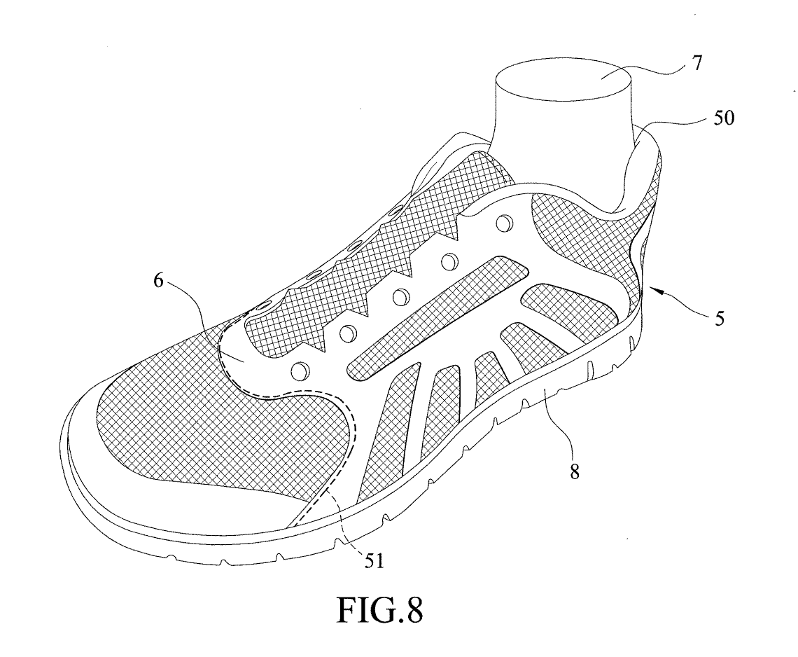

FIG. 9 is a schematic view illustrating the step of removing the shoe tree from the receiving space.

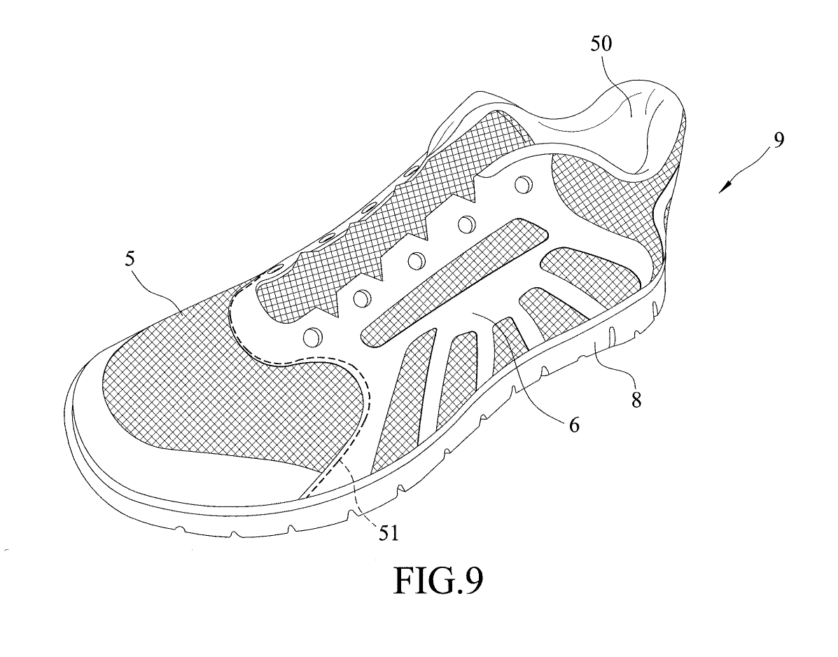

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

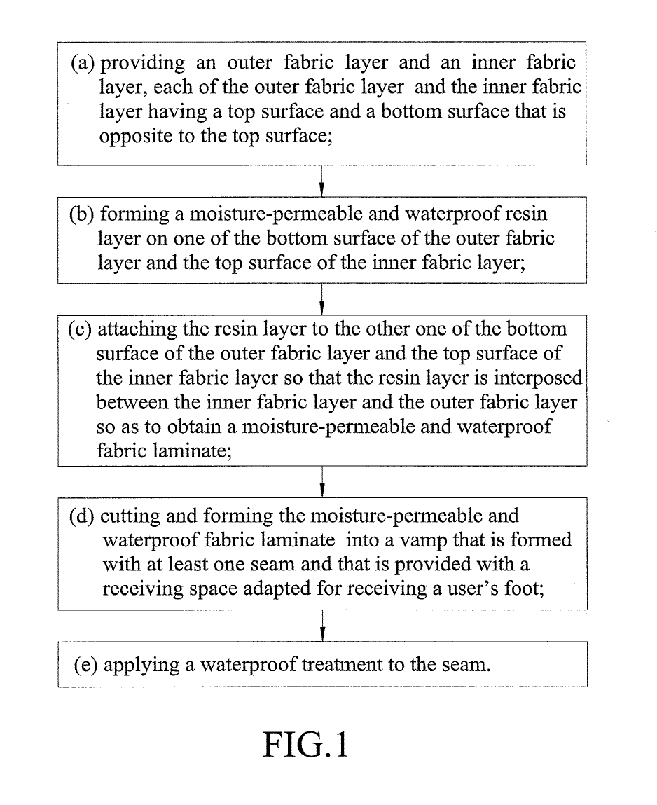

FIG. 1 shows the embodiment of a method of making a moisture-permeable and waterproof vamp for a shoe according to the disclosure, which includes the steps of (a) fabric layer-providing step, (b) resin layer forming step, (c) fabric laminate forming step, (d) vamp forming step, and (e) waterproof treating step.

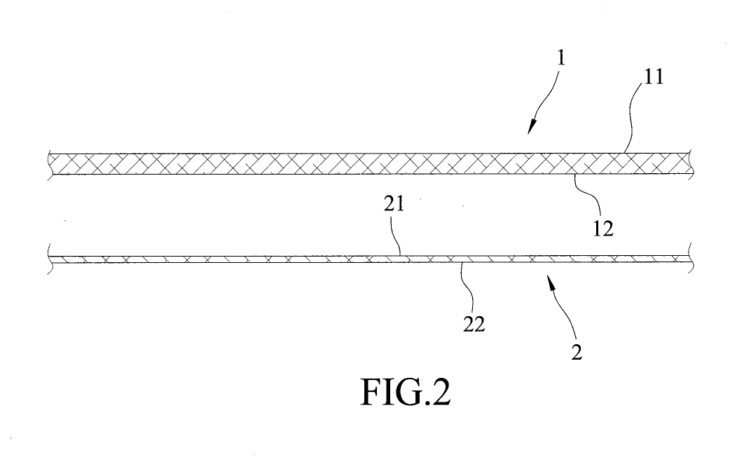

Referring to FIGS. 1 and 2, step (a) includes providing an outer fabric layer 1 and an inner fabric layer 2. Each of the outer fabric layer 1 and the inner fabric layer 2 has a top surface 11, 21 and a bottom surface 12, 22 that is opposite to the top surface 11, 21.

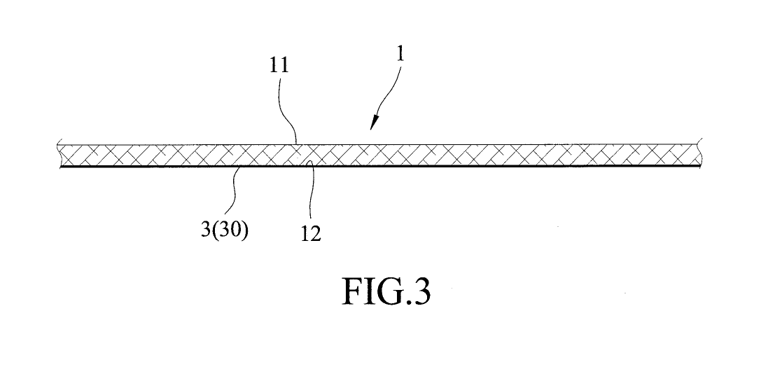

Referring to FIGS. 1 and 3, step (b) includes forming a moisture-permeable and waterproof resin layer 30 on one of the bottom surface 12 of the outer fabric layer 1 and the top surface 21 of the inner fabric layer 2. The moisture-permeable and waterproof resin layer 30 may be formed by coating a resin material on one of the bottom surface 12 of the outer fabric layer 1 and the top surface 21 of the inner fabric layer 2 to form a coating layer 3. In this embodiment, the resin material is coated on the bottom surface 12 of the outer fabric layer 1 to form the coating layer 3. The coating layer 3 is then dried to form the moisture-permeable and waterproof resin layer 30. In certain embodiments, the outer fabric layer 1 may be placed in an oven together with the coating layer 3 coated thereon at a predetermined heating temperature for a predetermined heating time to form the resin layer 30. In certain embodiments, the moisture-permeable and waterproof resin layer 30 may have a thickness ranging from 10 μm to 50 μm. The resin material may include polyurethane (PU) resin. In certain embodiments, the resin material may be polyurethane (PU) resin. The heating temperature and time may be adjusted based on the thickness of the moisture-permeable and waterproof resin layer 30 and the composition of the resin material. For instance, the heating temperature and time may range from 50° C. to 180° C. and 1 minute to 5 minutes, respectively.

In certain embodiments, step (b) is conducted by directly adhering the moisture-permeable and waterproof resin layer 30 onto one of the bottom surface 12 of the outer fabric layer 1 and the top surface 21 of the inner fabric layer 2. The moisture-permeable and waterproof resin layer 30 may be a commercially available product.

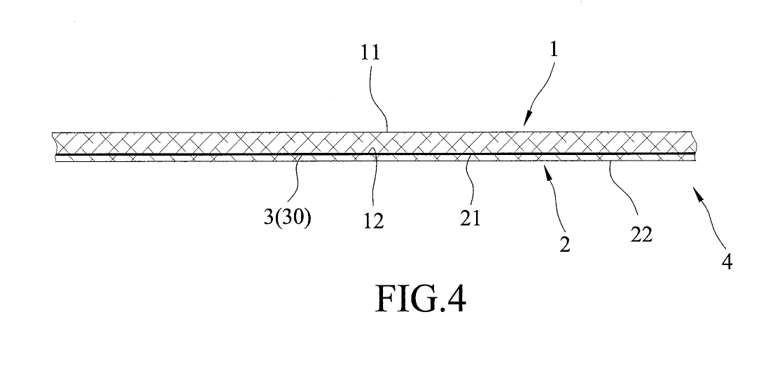

Referring to FIGS. 1 and 4, step (c) of the method of the disclosure includes attaching the resin layer 30 to the top surface 21 of the inner fabric layer 2 so that the resin layer 30 is interposed between the inner fabric layer 2 and the outer fabric layer 1 so as to obtain a moisture-permeable and waterproof fabric laminate 4. The attachment may be performed through an adhesive.

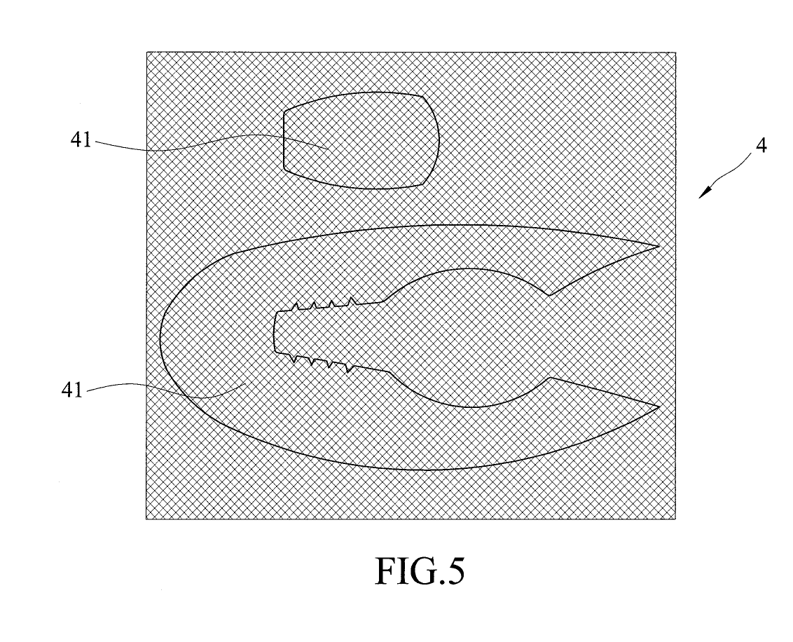

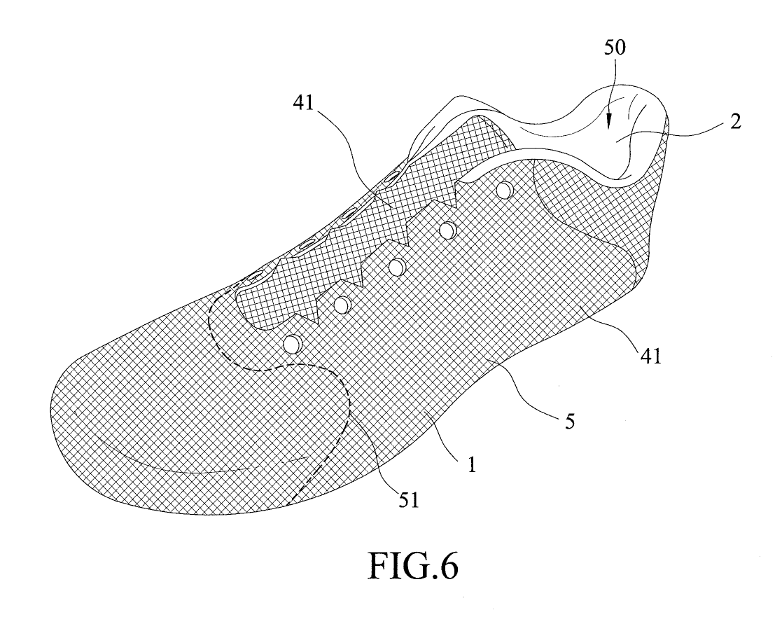

Referring to FIGS. 1, 5 and 6, step (d) of the method of the disclosure includes cutting and forming the moisture-permeable and waterproof fabric laminate 4 into a vamp 5. To be specific, the moisture-permeable and waterproof fabric laminate 4 is cut into a plurality of vamp-making pieces 41 and the vamp-making pieces 41 are sewn together to form a vamp 5. The vamp 5 has at least a seam 51 and is provided with a receiving space 50 for receiving a user's foot.

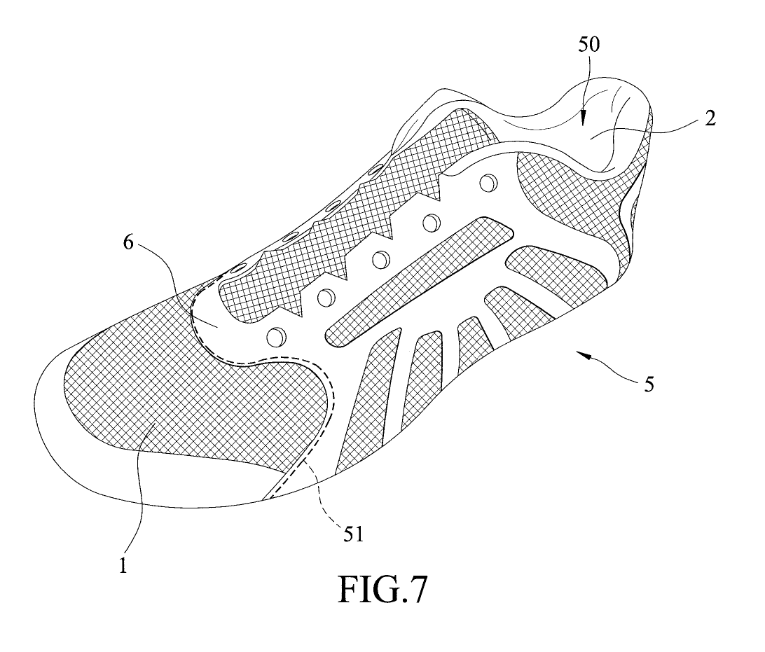

Referring to FIGS. 1 and 7, step (e) is then performed to apply a waterproof treatment to the seam 51. In certain embodiments, the waterproof treatment is conducted by applying a waterproof layer 6 to the seam 51 using high frequency welding techniques. In certain embodiments, the waterproof layer 6 is made from thermoplastic polyurethane (TPU) resin. In certain embodiments, the waterproof layer 6 may be formed into a pattern on the vamp 5 for decoration purposes.

The disclosure also provides an embodiment of a method of making a shoe. The method includes preparing the abovementioned moisture-permeable and waterproof vamp 5, disposing a shoe tree 7 in the receiving space 50 of the vamp 5 for maintaining a configuration of the vamp 5, then attaching a shoe sole 8 to a bottom of the vamp 5, and then removing the shoe tree 7 from the receiving space 50.

It should be noted that, if the outer fabric layer 1 is made from a fabric having relatively large pore size, it would be difficult to form the moisture-permeable and waterproof resin layer 30 on the bottom surface 12 of the outer fabric layer 1. Thus, the moisture-permeable and waterproof resin layer 30 can be formed on the top surface 21 of the inner fabric layer 2 followed by attaching the resin layer 30 to the bottom surface 12 of the outer fabric layer 1.

In certain embodiments, the top surface 11 of the outer fabric layer 1 in step (a) is subjected to a water repellent treatment to improve the waterproof property of the vamp.

The moisture-permeable and waterproof resin layer 30 of the vamp 5 may have different structures due to the type of the resin material. For example, the moisture-permeable and waterproof resin layer 30 may be in the form of a porous membrane or a non-porous membrane. The porous membrane has a plurality of pores, each of which has a diameter smaller than that of a water molecule and larger than that of a water vapor molecule. By way of a proper pore size arrangement, the porous membrane is waterproof and moisture-permeable. The non-porous membrane is free of pores and has a hydrophilic functional group-providing side and a hydrophobic functional group-providing side. When the non-porous membrane serves as the moisture-permeable and waterproof resin layer 30, the water vapor molecules will be adsorbed on the hydrophilic functional group-providing side, diffused to the hydrophobic functional group-providing side through capillary action and finally transpired to the environment.

As for the properties of the moisture-permeable and waterproof resin layer 30, the resin layer 30 may have a water resistance greater than 3000 mm as measured by the method in accordance with JIS L-1092B, and a moisture permeability greater than 3000 g/m³/24 hr as measured by the method in accordance with JIS L-1099B1.

In summary, with the moisture-permeable and waterproof resin layer 30 and the waterproof layer 6 covered on the seam 51, the vamp 5 of the shoe of this disclosure is both waterproof and moisture-permeable. Moreover, since the moisture-permeable and waterproof resin layer 30 is interposed between the outer and inner fabric layers 1, 2, the moisture-permeable and waterproof resin layer 30 is unlikely to be worn out as a result of friction, and thus the waterproof function of the moisture-permeable and waterproof fabric laminate 4 allows the vamp 5 to be relatively durable.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method of making a moisture-permeable and waterproof vamp for a shoe, comprising:
(a) providing an outer fabric layer and an inner fabric layer, each of the outer fabric layer and the inner fabric layer having a top surface and a bottom surface that is opposite to the top surface;
(b) forming a moisture-permeable and waterproof resin layer on one of the bottom surface of the outer fabric layer and the top surface of the inner fabric layer;
(c) attaching the resin layer to the other one of the bottom surface of the outer fabric layer and the top surface of the inner fabric layer so that the resin layer is interposed between the inner fabric layer and the outer fabric layer so as to obtain a moisture-permeable and waterproof fabric laminate;
(d) cutting and forming the moisture-permeable and waterproof fabric laminate into a vamp that is formed with at least one seam and that is provided with a receiving space adapted for receiving a user's foot; and
(e) applying a waterproof treatment to the seam.

2. The method of claim 1, wherein step (b) is conducted by coating a resin material on one of the bottom surface of the outer fabric layer and the top surface of the inner fabric layer to form a coating layer, and drying the coating layer.

3. The method of claim 2, wherein the resin material includes polyurethane resin.

4. The method of claim 1, wherein step (b) is conducted by directly adhering the resin layer onto one of the bottom surface of the outer fabric layer and the top surface of the inner fabric layer.

5. The method of claim 1, wherein step (e) is conducted by applying a waterproof layer to the seam using high frequency welding techniques.

6. The method of claim 1, wherein the top surface of the outer fabric layer in step (a) is subjected to a water repellent treatment.

7. The method of claim 1, wherein the resin layer has a water resistance greater than 3000 mm as measured by the method in accordance with JIS L-1092B.

8. The method of claim 1, wherein the resin layer has a moisture permeability greater than 3000 g/m²/24 hr as measured by the method in accordance with JIS L-1099B1.

9. The method of claim 1, wherein the resin layer has a thickness ranging from 10 μm to 50 μm.

10. A method for making a moisture-permeable and waterproof shoe, comprising:
preparing a moisture-permeable and waterproof vamp according to the method of claim 1; and
disposing a shoe tree in the receiving space of the vamp for maintaining a configuration of the vamp;
attaching a shoe sole to a bottom of the vamp; and
removing the shoe tree from the receiving space.
